(19) United States
(12) Patent Application Publication
(10) Pub. No.: US 2004/0141090 A1
(43) Pub. Date: Jul. 22, 2004

(54) Image capture device for electronic apparatus

(75) Inventor: Yu-Chiang Shih, Hsintien City (TW)

Correspondence Address: BACON & THOMAS, PLLC, 625 SLATERS LANE, FOURTH FLOOR, ALEXANDRIA, VA, 22314

(73) Assignee: Animation Technologies Inc., Hsintien City (TW)

(21) Appl. No.: 10/422,989

(22) Filed: Apr. 25, 2003

(30) Foreign Application Priority Data
Jan. 21, 2003 (TW) 092201102

(51) Int. Cl. H04N 5/225

(52) U.S. Cl. 348/376; 348/211.14

(57) ABSTRACT

An image capture device includes an image capture module, which uses an image sensor to convert field images obtained through a lens thereof into image data and has a viewfinder for finding the field, and an adapter pivoted to the image capture module and adapted to receive image data from the image capture module, to store received data in a RAM thereof, and to transmit image data to an external mobile computer or the like through a card bus thereof

### BACKGROUND OF THE INVENTION

1. Field of the Invention

The present invention relates generally to an image capture device connectable to an external electronic apparatus and, more particularly, to such an image capture device, which uses a CPU to set flags for image data received from an image sensor through a lens and an image processing circuit to reduce the size image data, enabling processed image data to be transmitted to an external electronic apparatus through a card bus interface. Therefore, the electronic apparatus to which the image capture device is connected has the function of a digital still camera as well as a digital video camera.

2. Description of the Related Art

Following fast development of computer technology, computers of relatively higher operating power and faster operating speed are known. In order to expand the data storage capacity of a mobile computer, electronic dictionary, digital camera, or the like, electronic cards such as network cards, modem cards, SCSI cards are developed. Electronic cards for use in a computer system are commonly of PCMCIA (Personal Computer Memory Card International Association) architecture. Various PCMCIA compatible interfaces such as PCMCIA to SCSI, PCMCIA to IDE, etc. have been developed for notebook computers. Most notebook computers support plug and play as well as hot plug. In additional to PCMCIA based memory cards, various other memory cards, such as MMCs (Multimedia Cards), CFs (CompactFlash Cards), SMCs (SmartMedia Cards), MSs (Memory Sticks), SDs (Secure Digital Memory Cards) are commercially available for use in a variety of electronic apparatus (digital cameras, digital video cameras, translation machines, personal digital assistants).

However, the interface of a PDA (personal digital assistant) is of CF (CompatFlash Card) architecture. Manufacturers commonly use a card bus of CF architecture to connect a digital camera to a PDA. A digital camera for this purpose is practical for taking still photos only, and the field image can only be displayed on the display screen of the PDA. Due to limited function of the CPU and software, a PDA cannot controls a digital camera to take motion picture.

Therefore, it is desirable to provide an image capture device for electronic apparatus that eliminates the aforesaid drawbacks.

### SUMMARY OF THE INVENTION

The present invention has been accomplished under the circumstances in view. It is the main object of the present invention to provide an image capture device for electronic apparatus, which enables the electronic apparatus to take photos as well as motion picture. It is another object of the present invention to provide an image capture device for electronic apparatus, which can be adjusted to view the field from different angels. According to one aspect of the present invention, the image capture device comprises an image capture module, and an adapter adapted to connect the image capture module to an external electronic apparatus and to transmit image data from the image capture module to the external electronic apparatus connected thereto. The image capture module comprises an image capture lens adapted to capture field images, and a circuit assembly. The circuit assembly of the image capture module comprises an image sensor adapted to receive field images from the lens and to convert received field images into image data. The adapter comprises a card bus for connection to an external electronic apparatus, and a circuit assembly. The circuit assembly of the adapter comprises a video bus interface electrically connected to the image sensor of the image capture module, a control unit (central processing unit), a random access memory controlled by the control unit to store image data received from the image sensor through the video bus interface, and a card bus interface connected to the card bus and controlled by the control unit to output image data to the card bus. The video bus interface transmits image data from the image sensor to the control unit for setting flags and for enabling image data to be stored in the random access memory under the control of the control unit. The control unit has an image processing circuit adapted to contract field image data. According to another aspect of the present invention, the image capture module has a viewfinder window for finding the field, and a round neck fastened pivotally with a joint at one side of the adapter.

### BRIEF DESCRIPTION OF THE DRAWINGS

FIG. 1 is a perspective view of an image capture device according to the present invention.

FIG. 2 is an exploded view of the image capture device according to the present invention.

FIG. 3 is a circuit block diagram of the image capture device according to the present invention.

FIG. 4 is an operation flow chart according to the present invention.

FIG. 5 is an applied view of the present invention, showing the image capture device installed in a PDA.

FIG. 6 is similar to FIG. 5 but showing the angular adjustment of the image capture module relative to the PDA.

### DETAILED DESCRIPTION OF THE INVENTION

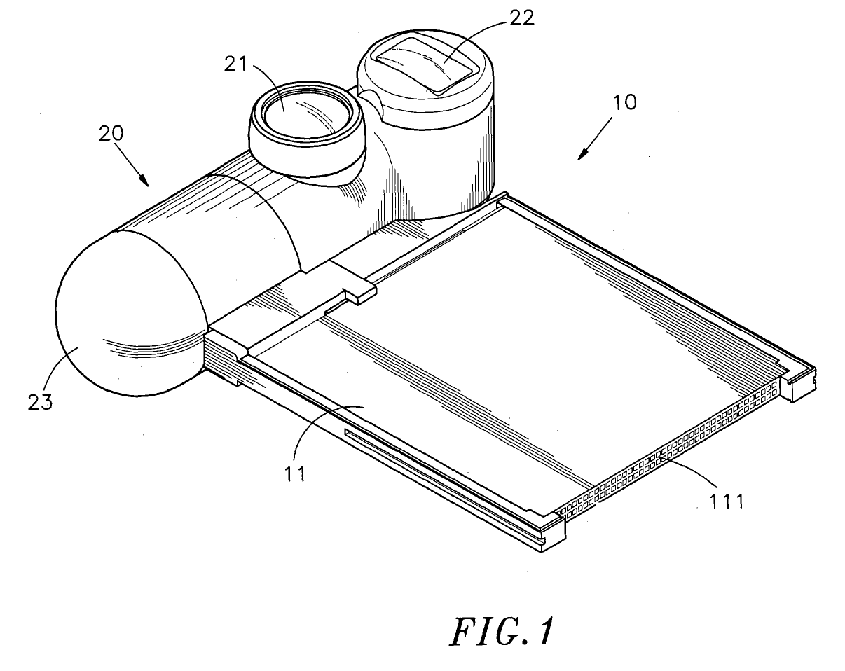

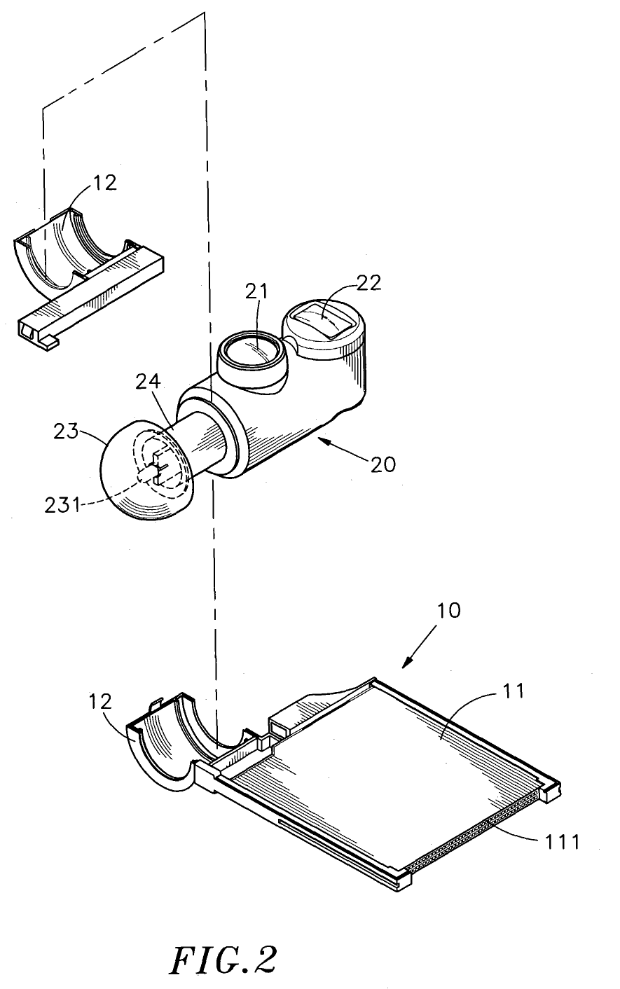

Referring to FIGS. 1 and 2, an image capture device is shown comprised of an adapter 10 and an image capture module 20 electrically connected to the adapter 10.

The adapter 10 comprises a card bus 11 and a joint 12 at one side of the card bus 11. The card bus 11 has a connecting side 111 opposite to the joint 12. The image capture module 20 comprises an image capture lens 21, a viewfinder window 22, an indicator 23, and a round neck 24. The joint 12 is shaped like a barrel, and formed of two symmetrical halves. The two symmetrical halves of the joint 12 can be opened for receiving the round neck 24 of the image capture module 20, and then closed to secure the image capture module 20 to the adapter 10, for enabling the image capture module 20 to be rotated relative to the joint 12.

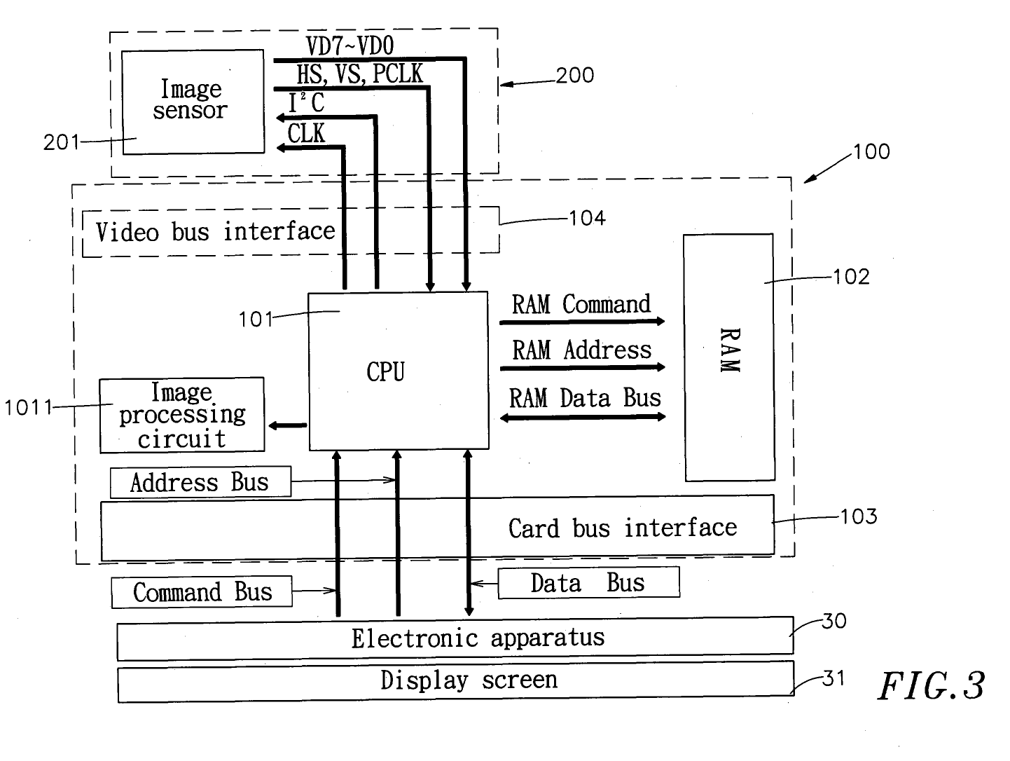

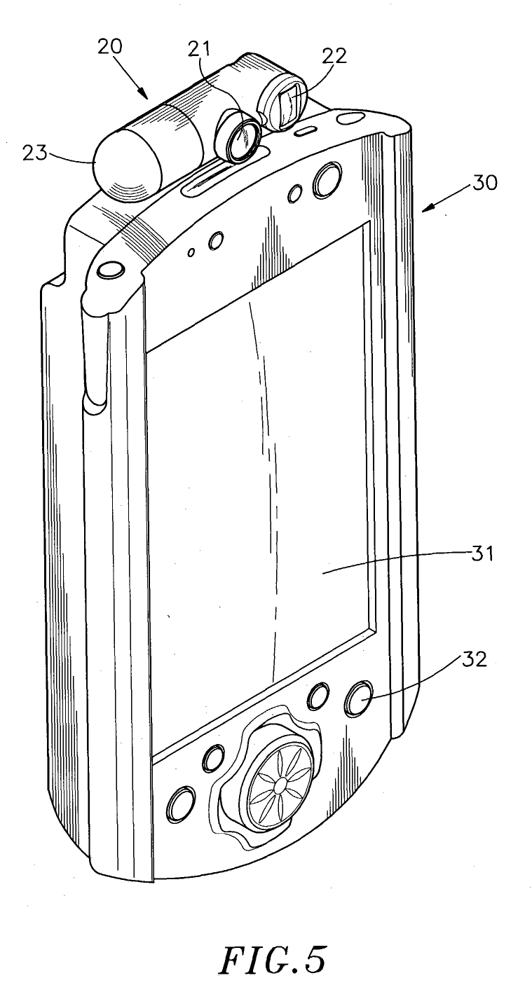

Referring to FIGS. 2 and 3, a first circuit assembly 100 and a second circuit assembly 200 are respectively installed in the card bus 11 of the adapter 10 and the image capture module 20. The first circuit assembly 100 comprises a control unit (CPU) 101, a RAM (random access memory) 102, a card bus interface 103, and a video bus interface 104. The RAM (random access memory) 102, the card bus interface 103, and the video bus interface 104 are respectively electrically connected to the control unit (CPU) 101. The control unit (CPU) 101 records signal flags for executing different controls, having an image processing circuit 1011 adapted to contract field image data (to one second, one fourth, or one eighth of the bits of field image data). The card bus interface 103 is connected to the corresponding slot of the electronic apparatus (computer or PDA) 30 through the connecting side 111 of the card bus 11 (see FIG. 5). The video bus interface 104 is adapted to receive image data from the second circuit assembly 200 in the image capture module 20 and transfer received image data to the control unit (CPU) 101. The second circuit assembly 200 has an image sensor 201 electrically connected to the video bus interface 104 and adapted to receive field images from the lens 21 and to convert received field images into image data.

Referring to FIGS. 3 and 5, when in use, the connecting side 111 of the card bus 11 of the adapter 10 is connected to the corresponding slot of the electronic apparatus 30 enabling the electronic apparatus 30to pick up field image data through the lens 21 of the image capture module 20. Image data picked by the lens 21 is transmitted to the image sensor 201 of the second circuit assembly 200, enabling the video bus interface 104 to transmit field image data to the control unit (CPU) 101 of the first circuit assembly 100 in the adapter 10 for setting flag and then for storing in the RAM 102. When the status of the set flag ended, the image processing circuit 1011 of the control unit (CPU) 101 sets the ratio of contract (one second, one fourth, or one eighth). When the ratio of contact set, the control unit (CPU) 101 controls the RAM 102 to transfer storage image data to the external electronic apparatus (computer, or PDA) 30 through the card bus interface 103 for storage in storage means of the external electronic apparatus 30 and for display on the display screen 31 of the electronic apparatus 30 when converted into field.

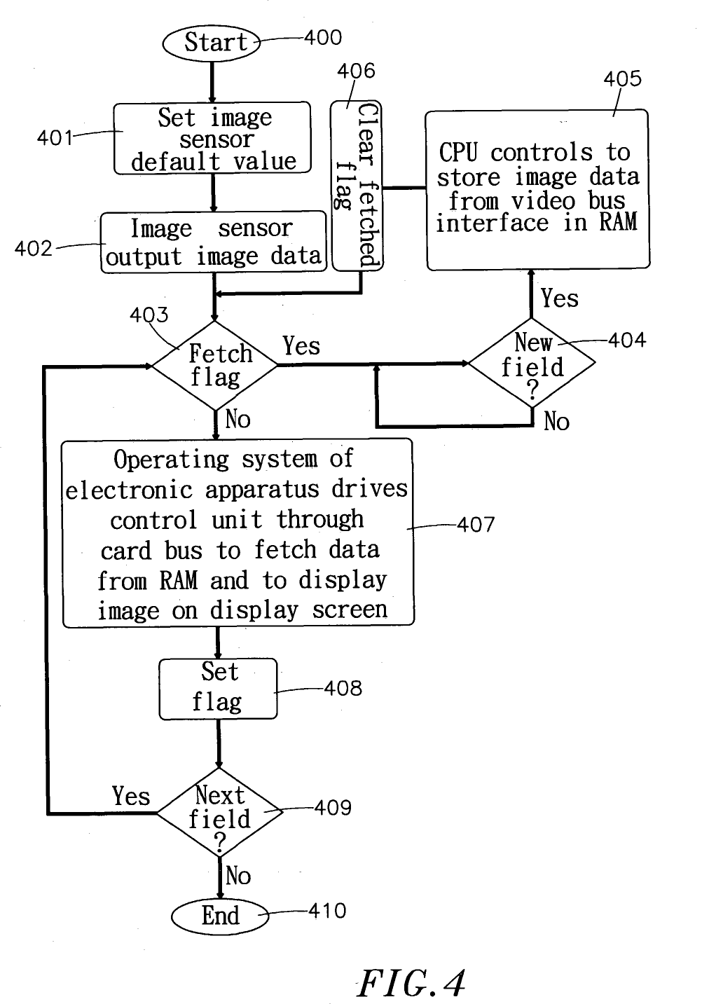

Referring to FIGS. 3 and 4, when the user operating the image capture device to take photos after the connection of the image capture device to the electronic apparatus 30, the image capture device runs subject to the following steps:

(400) Start;

(401) Set image sensor 201's default value;

(402) Image sensor 201 output field image data to the control unit (CPU) 101 through the video bus interface 104;

(403) Fetch flag, and then proceed to step (404) when succeeded, or to step

(407) when failed;

(404) New field? Proceed to step (405) when positive, or repeat step (404) when negative;

(405) The control unit (CPU) 101 controls the video bus interface 104 to store image data in the RAM 102;

(406) Clear fetched flag, and then proceed to step (403);

(407) The operating system of the electronic apparatus (computer system or PDA) 30 drives the control unit (CPU) 101 through the card bus interface 103 to fetch image data from the RAM 102, and then convert image data into field for display on the display screen 31;

(408) Set flag;

(409) Next field? Return to step (403) if positive, or proceed to step (410);

(410) End the system.

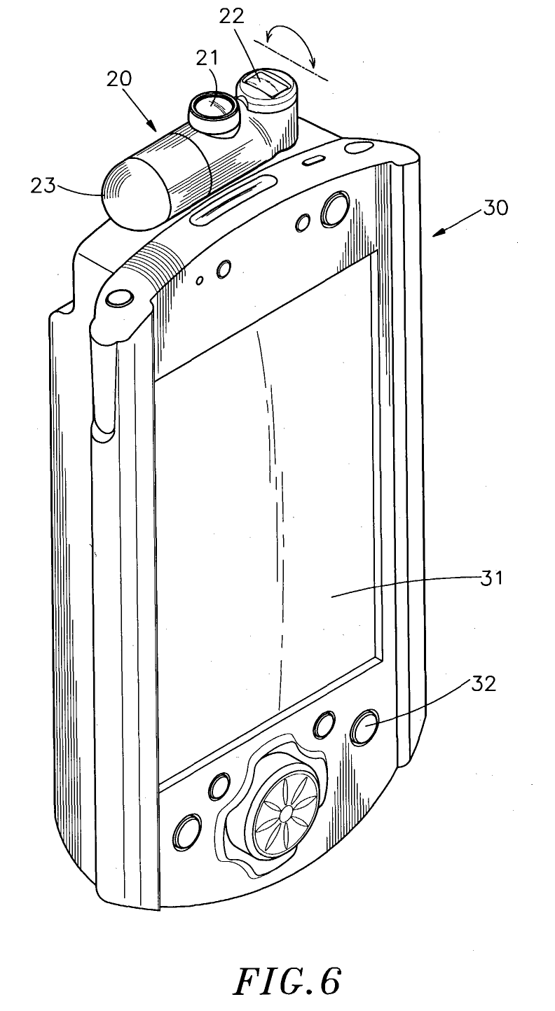

Referring to FIGS. 2, 5, and 6, the round neck24 of the image capture module 20 is fastened pivotally with the joint 12 so that the image capture module 20 can be rotated in the joint 12 to move the lens 21 and the viewfinder window 22 to the desired angle.

When photographing, the user can find the view of the field through the viewfinder window 22 or preview field images through the display screen 31 of the electronic apparatus 30, and operate the buttons 32 of the electronic apparatus 30 to select the function of taking still photos or the function of taking motion picture.

Referring to FIGS. 1 and 2 again, the indicator 23 is a transparent or semitransparent shell having an indicator light 231 on the inside adapted to indicate data output status of the image capture device. Further, the connecting side 111 of the card bus 11 of the adapter 10 can be of CF (CompactFlash card), SD (Secure Digital Card), or PCMCIA (Personal Computer Memory Card International Association) architecture.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An image capture device comprising:
an image capture module, said image capture module comprising an image capture lens adapted to capture field images, and a circuit assembly, the circuit assembly of said image capture module comprising an image sensor adapted to receive field images from said lens and to convert received field images into image data;. And
an adapter adapted to connect said image capture module to an external electronic apparatus and to transmit image data from said image capture module to the external electronic apparatus connected thereto, said adapter comprising a card bus for connection to an external electronic apparatus, and a circuit assembly, the circuit assembly of said adapter comprising a video bus interface electrically connected to said image sensor of said image capture module, a control unit (central processing unit), a random access memory controlled by said control unit to store image data received from said image sensor through said video bus interface, and a card bus interface connected to said card bus and controlled by said control unit to output image data to said card bus, said video bus interface transmitting image data from said image sensor to said control unit for setting flags and for enabling image data to be stored in said random access memory under the control of said control unit, said control unit having an image processing circuit adapted to contract field image data.

2. The image capture device as claimed in claim 1, wherein said image capture module comprises a viewfinder window.

3. The image capture device as claimed in claim 1, wherein said image capture module comprises an indicator having an indicator light adapted to indicate data transmission status of said image capture module.

4. The image capture device as claimed in claim 1, wherein said adapter comprises a joint at one side thereof; said image capture module comprises a round neck fastened pivotally with the joint of said adapter.

5. The image capture device as claimed in claim 1, wherein said card bus of said adapter has a connecting side made subject to one connecting port of an electronic apparatus.

6. The image capture device as claimed in claim 1, wherein the connecting side of said card bus is made subject to CF (CompactFlash Card) architecture.

7. The image capture device as claimed in claim 1, wherein the connecting side of said card bus is made subject to PCMCIA (Personal Computer Memory Card International Association) architecture.

8. The image capture device as claimed in claim 1, wherein the connecting side of said card bus is made subject to SD (Secure Digital Card) architecture.
